(19) United States
(12) Patent Application Publication
(10) Pub. No.: US 2023/0169336 A1
(43) Pub. Date: Jun. 1, 2023

(54) DEVICE AND METHOD WITH STATE TRANSITION LINEARIZATION

(71) Applicants: Samsung Electronics Co., Ltd., Suwon-si (KR); Seoul National University R&DB Foundation, Seoul (KR)

(72) Inventors: Minsu KO, Suwon-si (KR); Jaekyeom KIM, Seoul (KR); Seohong PARK, Seoul (KR); Gunhee KIM, Seoul (KR); Sungjoo SUH, Seongnam-si (KR)

(73) Assignees: Samsung Electronics Co., Ltd., Suwon-si (KR); Seoul National University R&DB Foundation, Seoul (KR)

(21) Appl. No.: 17/989,320

(22) Filed: Nov. 17, 2022

(30) Foreign Application Priority Data
Nov. 29, 2021 (KR) 10-2021-0166946

(51) Int. Cl. G06N 3/08

(52) U.S. Cl. CPC G06N 3/08

(57) ABSTRACT

An electronic device includes: a state observer configured to observe a state of the electronic device according to an environment interactable with the electronic device; one or more processors configured to: determine a skill based on the observed state; determine a goal based on the determined skill and the observed state; and determine, based on the state and the determined goal, an action causing a linear state transition of the electronic device in a direction toward the determined goal in a state space; and a controller configured to control an operation of the electronic device based on the determined action.

### CROSS-REFERENCE TO RELATED APPLICATION

This application claims the benefit under 35 USC § 119(a) of Korean Patent Application No. 10-2021-0166946, filed on Nov. 29, 2021 in the Korean Intellectual Property Office, the entire disclosure of which is incorporated herein by reference for all purposes.

### BACKGROUND

### 1. Field

The following description relates to a device and method with state transition linearization.

### 2. Description of Related Art

To solve an issue of classifying input patterns into specific group, neural networks may use an algorithm that with a learning ability. The neural network may generate a mapping between input and output patterns based on the algorithm. In addition, the neural network may have a generalization ability to generate a relatively correct output for an input pattern that has not been used for learning. The neural network may also be trained through reinforcement learning.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic device includes: a state observer configured to observe a state of the electronic device according to an environment interactable with the electronic device; one or more processors configured to: determine a skill based on the observed state; determine a goal based on the determined skill and the observed state; and determine, based on the state and the determined goal, an action causing a linear state transition of the electronic device in a direction toward the determined goal in a state space; and a controller configured to control an operation of the electronic device based on the determined action.

For the observing, the state observer may be configured to perform either one or both of sensing a change in a physical environment for the electronic device and collection of a data change related to a virtual environment.

For the determining of the skill, the one or more processors may be configured to determine a skill vector representing the skill to be applied to the observed state, based on a state vector representing the observed state, using a skill determining model based on machine learning.

The one or more processors may be configured to: control the controller with an action determined using an action determining model and a goal determining model based on a temporary skill determined using a skill determining model for an observed state; determine a reward according to a state transition by the action performed by the controller; and update a parameter of the skill determining model based on the determined reward.

For the determining of the goal, the one or more processors may be configured to determine a goal state vector representing the goal, based on a state vector representing the observed state and a skill vector representing the determined skill, using a goal determining model based on machine learning.

The one or more processors may be configured to: determine a goal state trajectory using the controller and an action determining model for sample goals extracted from randomly extracted sample skills using a goal sampling model; determine a value of an objective function for each goal state trajectory; and update a parameter of the goal determining model based on the determined objective function.

For the determining of the action based on the state and the determined goal, the one or more processors may be configured to determine an action vector representing the action, based on a state vector representing the observed state and a goal state vector representing the determined goal, using an action determining model based on machine learning.

The one or more processors may be configured to: determine an action trajectory by determining an action using the action determining model for each sampled goal; determine an objective function value for each determined action trajectory; store the action trajectory and the objective function value in a replay buffer; and update a parameter of the action determining model based on the stored action trajectory and the objective function value.

For the determining of the goal, the one or more processors may be configured to determine the goal based on the determined skill and the observed state while maintaining the determined skill for a predetermined number of times using a skill determining model.

The one or more processors may be configured to determine the action based on the determined goal and the observed state while maintaining the determined goal for a predetermined number of times using a goal determining model.

In another general aspect, a processor-implemented method includes: observing a state of the electronic device according to an environment interactable with the electronic device; determining a skill based on the observed state; determining a goal based on the determined skill and the observed state; determining an action causing a linear state transition of the electronic device in a direction toward the determined goal in a state space based on the state and the determined goal; and controlling an operation of the electronic device based on the determined action.

The observing may include performing either one or both of sensing a change in a physical environment for the electronic device and collection of a data change related to a virtual environment.

The determining of the skill may include determining a skill vector representing the skill to be applied to the observed state, based on a state vector representing the observed state, using a skill determining model based on machine learning.

The method may include: controlling a controller with an action determined using an action determining model and a goal determining model based on a temporary skill determined using a skill determining model for an observed state; determining a reward according to a state transition by the action performed by the controller; and updating a parameter of the skill determining model based on the determined reward.

The determining of the goal may include determining a goal state vector representing the goal, based on a state vector representing the observed state and a skill vector representing the determined skill, using a goal determining model based on machine learning.

The method may include: determining a goal state trajectory using a controller and an action determining model for sample goals extracted from randomly extracted sample skills using a goal sampling model; determining a value of an objective function for each goal state trajectory; and updating a parameter of the goal determining model based on the determined objective function.

The determining of the action based on the state and the determined goal may include determining an action vector representing the action, based on a state vector representing the observed state and a goal state vector representing the determined goal, using an action determining model based on machine learning.

The method may include: determining an action trajectory by determining an action using the action determining model for each sampled goal; determining an objective function value for each determined action trajectory; storing the action trajectory and the objective function value in a replay buffer; and updating a parameter of the action determining model based on the stored action trajectory and the objective function value.

The determining of the goal may include determining the goal based on the determined skill and the observed state while maintaining the determined skill for a predetermined number of times using a skill determining model.

In another general aspect, one or more embodiments include a non-transitory computer-readable storage medium storing instructions that, when executed by one or more processors, configure the one or more processors to perform any one, any combination, or all operations and methods described herein.

In another general aspect, a processor-implemented method includes: one or more processors configured to: determine, using a skill determining model, a skill based on a state of the electronic device observed according to an environment interactable with the electronic device; determine, using goal determining model, a goal based on the determined skill and the observed state; determine, using an action determining model, an action causing a state transition of the electronic device based on the state and the determined goal; and update, based on the determined action, a parameter of any one or any combination of any two or more of the skill determining model, the goal determining model, and the action determining model.

The electronic device may include: a state observer configured to observe the state of the electronic device; and a controller configured to control an operation of the electronic device based on the determined action.

For the observing of the state, the state observer may include one or more sensors configured to sense the state of the electronic device, and for the controlling of the operation, the controller may include one or more actuators configured to control a movement of the electronic device.

Other features and aspects will be apparent from the following detailed description, the drawings, and the claims.

### BRIEF DESCRIPTION OF THE DRAWINGS

FIG. 1 illustrates an example of a neural network.

FIG. 2 illustrates an example of reinforcement learning performed in an electronic device.

FIG. 3 illustrates an example of a linearized state transition according to an action determined by an action determining model.

FIGS. 4 and 5 illustrate examples of training a skill determining model.

FIGS. 6 and 7 illustrate examples of training a goal determining model.

FIGS. 8 and 9 illustrate examples of training an action determining model.

FIG. 10 illustrates a state space discovery ability by an action determining model.

FIG. 11 is a block diagram illustrating an example of an electronic device.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known, after an understanding of the disclosure of this application, may be omitted for increased clarity and conciseness.

Although terms such as “first,” “second,” and “third” are used to explain various members, components, regions, layers, or sections, these members, components, regions, layers, or sections are not to be limited by these terms. Rather, these terms should be used only to distinguish one member, component, region, layer, or section from another member, component, region, layer, or section. For example, a “first” member, component, region, layer, or section referred to in the examples described herein may also be referred to as a “second” member, component, region, layer, or section without departing from the teachings of the examples.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween. Likewise, similar expressions, for example, “between” and “immediately between,” and “adjacent to” and “immediately adjacent to,” are also to be construed in the same way. As used herein, the term “and/or” includes any one and any combination of any two or more of the associated listed items.

The terminology used herein is for describing various examples only and is not to be used to limit the disclosure. The articles “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof. The use of the term “may” herein with respect to an example or embodiment (for example, as to what an example or embodiment may include or implement) means that at least one example or embodiment exists where such a feature is included or implemented, while all examples are not limited thereto.

Unless otherwise defined, all terms including technical or scientific terms used herein have the same meaning as commonly understood by one of ordinary skill in the art to which examples belong and after an understanding of the present disclosure. It will be further understood that terms, such as those defined in commonly-used dictionaries, should be interpreted as having a meaning that is consistent with their meaning in the context of the relevant art and the present disclosure, and will not be interpreted in an idealized or overly formal sense unless expressly so defined herein.

Hereinafter, examples will be described in detail with reference to the accompanying drawings. Regarding the reference numerals assigned to the elements in the drawings, it should be noted that the same elements will be designated by the same reference numerals, and redundant descriptions thereof will be omitted.

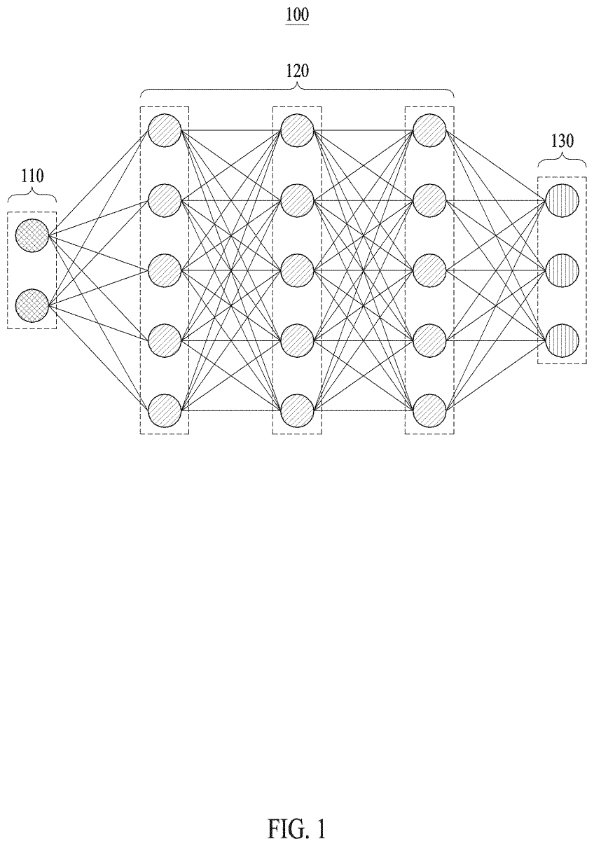

FIG. 1 illustrates an example of a neural network.

An electronic device may determine an action for an observed state using one or more machine learning models and perform an operation according to the determined action. Each of the models may be, for example, a machine learning structure and may include a neural network 100.

The neural network 100 may be, or correspond to an example of, a deep neural network (DNN). The DNN may include a fully connected network, a deep convolutional network, and/or a recurrent neural network. The neural network 100 may perform various tasks (e.g., robot control based on sensed surrounding information) by mapping input data and output data in a non-linear relationship to each other based on deep learning. Through supervised and/or unsupervised learning (e.g., reinforcement learning) as a machine learning technique, input data and output data may be mapped to each other.

Referring to FIG. 1, the neural network 100 includes an input layer 110, a hidden layer 120 (e.g., one or more hidden layers), and an output layer 130. The input layer 110, the hidden layer 120, and the output layer 130 may each include a plurality of nodes.

For ease of description, FIG. 1 illustrates that the hidden layer 120 includes three layers. However, a number of layers included in the hidden layer 120 is not limited thereto. Further, FIG. 1 illustrates the neural network 100 including a separate input layer to receive input data. However, the input data may be input directly into the hidden layer 120 (e.g., into a first layer of the hidden layer 120). In the neural network 100, nodes of layers excluding the output layer 130 may be connected to nodes of a subsequent layer through links to transmit output signals. The number of links may correspond to the number of nodes included in the subsequent layer.

An output of an activation function related to weighted inputs of nodes included in a previous layer may be input into each node of the hidden layer 120. The weighted inputs may be obtained by multiplying inputs of the nodes included in the previous layer by a weight. The weight may be referred to as a parameter of the neural network 100. The activation function may include a sigmoid, a hyperbolic tangent (tanh), and a rectified linear unit (ReLU), and a non-linearity may be formed in the neural network 100 by the activation function. The weighted inputs of the nodes included in the previous layer may be input into the nodes of the output layer 130.

When the width and the depth of the neural network 100 are sufficiently great, the neural network 100 may have a capacity sufficient to implement a predetermined function. When the neural network 100 learns a sufficient quantity of training data through an appropriate training process, the neural network 100 may achieve an optimal estimation performance.

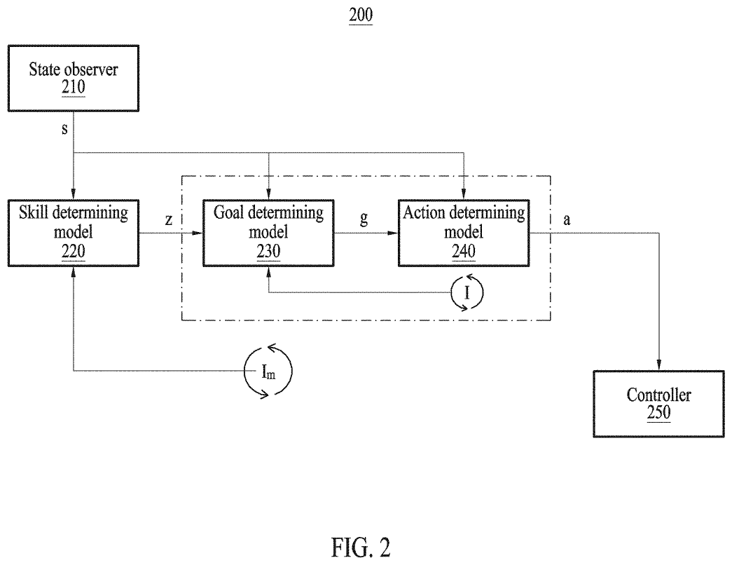

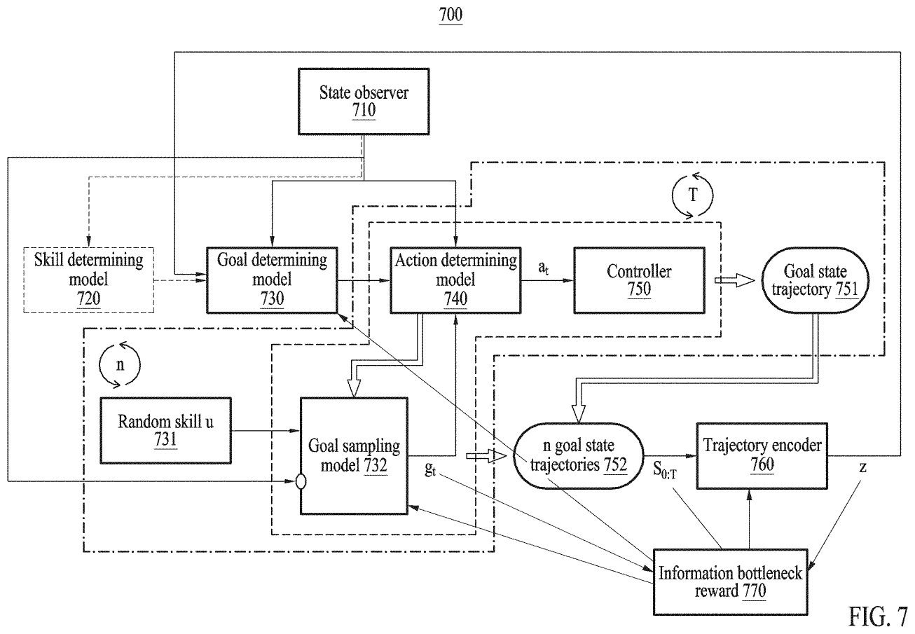

Although the neural network 100 has been described above as an example of a recognition model, the recognition model is not limited to the neural network 100 and may be implemented as various structures. For reference, an electronic device may include a skill determining model, a goal determining model, an action determining model, a goal sampling model, and/or a trajectory encoder. Each model may be a model in which a policy is implemented based on machine learning, and non-limiting examples will be described later with reference to FIGS. 2 and 7.

The above-described machine learning model may be trained through reinforcement learning, for example. A reinforcement learning-based machine learning model may be trained to maximize a reward given from outside. A reward function for reinforcement learning may be directly and/or manually defined, but is not limited thereto. For example, a reinforcement learning agent may previously train a machine learning model on useful skills without human supervision. The reinforcement learning agent may interpret a given task in the future through a combination of learned skills and quickly learn parameters for the task. The reinforcement learning using the skills may be referred to as unsupervised skill discovery. For reference, the reinforcement agent may be executed by an electronic device. In this disclosure, for convenience of explanation, a state of the reinforcement learning agent according to an environment is described as a state of the electronic device, but is not limited thereto. When a module executing the reinforcement learning agent (e.g., a module including a state observer and a controller) is implemented as a device separated from the electronic device, the state of the agent may be a state observed by the module.

In a field of reinforcement learning, a skill may be a pattern, a tendency, a policy, and/or a strategy of selecting an action of an agent in a given time period for the states given to the agent (e.g., an electronic device). The skill may also be an option. For example, the skill may be defined as a skill latent variable z in a skill latent space, and the skill latent variable z may be expressed in a form of a skill latent vector (e.g., a skill vector). The skill latent variable z may be a random variable. The skill latent space may be a space in which skills to be acquired by an agent are expressed. The skill latent vector may indicate a skill in the skill latent space, and may also be interpreted as coordinates representing a point of the skill in the skill latent space.

For reference, the agent may determine different actions when different skills are applied to the same situation. As an example, when the electronic device (e.g., a device executing an agent) derives a first skill vector for an observed state vector, the electronic device may perform a first action on the state vector while the first skill vector is given. As another example, when a second skill vector is given to the same state vector, the electronic device may perform a second action different from the first action on the corresponding state vector. When determining the skill, the electronic device may apply the same skill to states of each time step for a plurality of time steps. The electronic device may replace and/or change a skill to be applied to the observed state by determining a new skill each time that a plurality of time steps have elapsed. However, it is merely an example. Once the skill is determined, the electronic device may maintain the determined skill during an episode (e.g., a series of operations performed from activation of the electronic device to a termination).

From a state observed based on the skill determining model, the electronic device may determine a skill to be applied to the corresponding state. The electronic device may learn an effective skill even in an environment with complex dynamics by considering useful characteristics such as interpretability of the skill latent variable and the usefulness of action paths.

FIG. 2 illustrates an example of reinforcement learning performed in an electronic device.

An electronic device 200 may perform a reinforcement learning agent control and training in a complex environment. For example, the electronic device 200 may teach each model useful and interpretable skills to be applied to an interactable environment, in an unsupervised manner.

An environment may include all environments interactable with the electronic device 200 and may be defined as or include, for example, a state space, an action space, and a state transition probability distribution according to an action among tuples according to the Markov decision process (MDP). The environment may include, for example, a physical environment of the electronic device 200 (e.g., an area around a point where the electronic device 200 is located) and/or a virtual environment (e.g., a virtual reality environment created or simulated by the electronic device 200). The physical environment may be or represent an environment that physically interacts with the electronic device 200. The virtual environment may be an environment that interacts non-physically (e.g., virtually) with the electronic device 200, and may be or represent an environment in which data change occurs in a device inside or outside the electronic device 200.

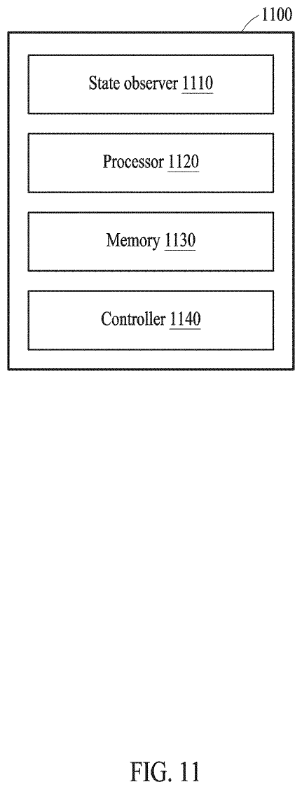

The electronic device 200 may include a state observer 210, a skill determining model 220, a goal determining model 230, the action determining model 240, and a controller 250. The skill determining model 220, the goal determining model 230, and the action determining model 240 may be stored in a memory (e.g., a memory 1130 of FIG. 11), a non-limiting example of which to be described later.

The state observer 210 may observe a state of the electronic device 200 according to an environment in a state space representing an environment interactable with the electronic device 200. The state observer 210 may perform either one or both of sensing a change in a physical environment of the electronic device and collecting data change related to a virtual environment. For example, the electronic device 200 may interact with the environment through any one or any combination of any two or more of an operation, a function, and an action of the electronic device 200. The state of the electronic device 200 may be expressed as a state vector. The state vector may be interpreted as coordinates representing a point corresponding to the state of the electronic device 200 in the state space. The state of the electronic device 200 may change by an interaction between the electronic device 200 and the environment. For example, in response to any one or any combination of any two or more of the operation, the function, and the action of the electronic device 200 being applied to the environment, the state of the electronic device 200 may change.

For example, when the electronic device 200 is or includes a robot cleaner, a physical environment of the electronic device 200 may include physical areas (e.g., house rooms) that the robot cleaner is to potentially visit, and the state of the electronic device 200 may be a location in the house. When the electronic device 200 runs a voice assistant, the physical environment of the electronic device 200 may include information (e.g., illuminance, ambient image, ambient sound, and/or whether the electronic device 200 is touched) to be sensed by a sensor (e.g., an illuminance sensor, a camera sensor, a microphone, and/or a touch sensor) of the state observer 210. When the electronic device 200 executes a game application, the virtual environment of the electronic device 200 may include objects interacting with the avatar in the in-game world of the avatar in the game application, other avatars, and non-playable character (NPC) objects. However, the environment, the state, and the state vector of the electronic device 200 are not limited to the foregoing examples, and may be defined in various ways according to the usage and purpose of the electronic device 200.

The state observer 210 may include, for example, a sensor (e.g., one or more sensors), low-level software, and/or a simulator. The sensor may sense a variety of information related to the environment (e.g., electromagnetic waves, sound waves, electrical signals, and/or heat). The sensor may include, for example, any one or any combination of any two or more of a camera sensor, a sound sensor (e.g., a microphone), an electrical sensor, a thermal sensor, an illuminance sensor, and a touch sensor. The low-level software may include software that pre-processes raw data read from the sensor.

The skill determining model 220 may output data indicating the skill latent variable z of a skill to be applied to an observed state s for the electronic device 200 based on an input of the observed state s. The electronic device may determine a skill vector representing a skill z to be applied to the observed state s, from a state vector representing the observed state s, using the skill determining model 220 based on machine learning. For example, the electronic device 200 may output a probability distribution (e.g., skill probability distribution) for a point (e.g., coordinates) in the skill latent space of the skill vector to be applied to the observed state s based on the skill determining model 220 from the skill vector representing the observed state s. For example, the skill probability distribution may be expressed as the mean and variance of points where the skill latent variable z to be applied for the state s in the skill latent space is likely to be located. The skill probability distribution may follow a Gaussian distribution. For example, when the skill latent space is a d-dimensional space, the skill vector may be expressed as a d-dimensional vector. The output of the skill determining model 220 may include average coordinates and variance for each dimension in which the applied skill latent variable z is likely to be located. For example, the output of the skill determining model 220 may be 2D data. Here, d may be an integer of 1 or more. As an example, the electronic device 200 may determine the skill vector indicating a point indicated by the mean in the output of the skill determining model 220 as the skill latent variable z. As another example, the electronic device 200 may determine, as the skill latent variable z, the skill vector corresponding to coordinates in the skill latent space determined by performing the above-described probability trial based on the mean and variance.

For reference, as well as the skill latent variable, as described above, a state variable, a goal variable, and an action variable may also include average coordinates and variance for each dimension of the corresponding latent space as random variables.

The skill determining model 220 may also be expressed as, or include, the skill determination policy π_{ξ}(z|s). π_{ξ}(z|s) is a policy function and may output the probability distribution of the skill latent variable z in the given state s. As described above, the output of the skill determination policy π_{ξ}(z|s) may include, for example, the average point and variance for each dimension of the d-dimensional skill latent space. The electronic device 200 may determine, for the given state s, the skill vector sampled with π_{ξ}(z|s) or the skill vector (e.g., the skill vector representing the point indicated by the mean in the output of the skill determining model 220) that maximizes a value of π_{ξ}(z|s) as the probability distribution.

The goal determining model 230 may output data indicating a goal g for the determined skill and the observed state s. The electronic device may determine the goal skill vector representing the goal g, from the skill vector representing the determined skill z and the skill vector representing the observed state s, using the goal determining model 230 based on the machine learning. For example, the electronic device 200 may output a probability distribution (e.g., goal probability distribution) representing a point (e.g., coordinates) in a goal latent space of a goal vector based on the goal determining model 230 from the skill vector representing the observed state s and the skill vector indicating the skill. A goal probability distribution may be expressed as the mean and variance of points in the goal latent space where the goal g for the skill and the state s is likely to be located. The goal probability distribution may follow the Gaussian distribution.

The goal determining model 230 may also be expressed as, or include, a goal determination policy π_{θ}_{_{Z}}(g|s, z). π_{θ}_{_{Z}}(g|s, z) is a policy function and may output the probability distribution of the goal g in the skill latent variable z and the given state s. The output of π_{θ}_{_{Z}}(g|s, z) may include, for example, an average point and variance for each dimension of the multidimensional goal latent space. The electronic device 200 may determine, for the given state s and the skill latent variable z, the goal vector sampled through a probability trial in which π_{θ}_{_{Z}}(g|s, z) or the goal vector (e.g., the goal vector indicating a point indicated by the mean in the output of the goal determining model 230) that maximizes a value of π_{θ}_{_{Z}}(g|s, z) is the probability distribution.

The action determining model 240 may output data indicating an action a for the observed state s and the determined goal g. For example, the electronic device 200 may output the probability distribution (e.g., action probability distribution) indicating a point (e.g., coordinates) in an action latent space of an action vector based on the action determining model 240 from the skill vector representing the observed state s and the goal vector representing the determined goal g. An action probability distribution may be expressed as the mean and variance of points in the action latent space where the action a for the state s and the goal g is likely to be located. The action probability distribution may follow the Gaussian distribution.

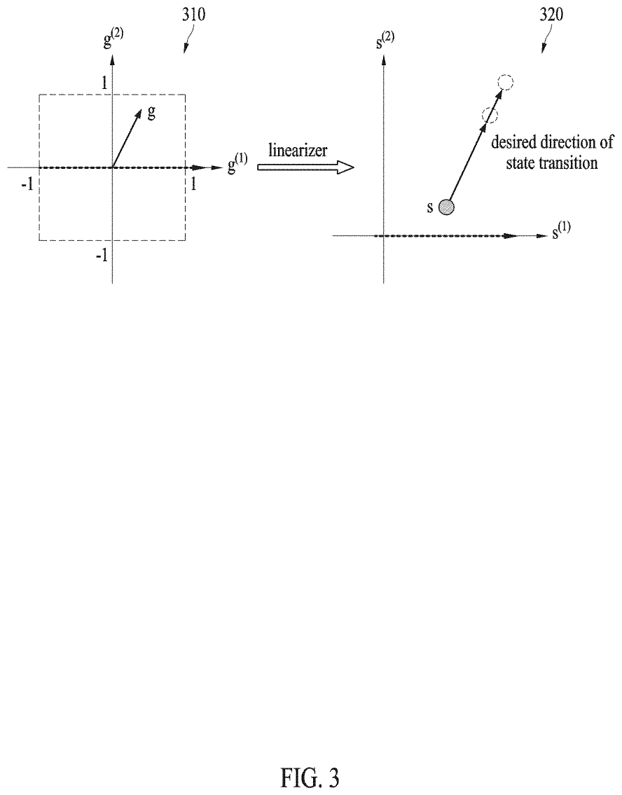

The action determining model 240 may also be expressed as, or include, a linearization policy π^{lin}(aₜ|sₜ, g)). π^{lin}(aₜ|sₜ, g)) is a policy function and may output a probability distribution of an action aₜ in a given state sₜ and the goal g. sₜ denotes a state at a t-th time step, and aₜ denotes an action at the t-th time step. A non-limiting example of the action determining model 240 will be further described in greater detail with reference to FIG. 3.

The controller 250 may perform and/or execute an action indicated by the action vector calculated (e.g., determined) as described above. For example, the controller 250 may perform an action and a function corresponding to an action determined using the action determining model 240. The controller 250 may cause a change in an environment by executing the action aₜ. The controller 250 may include, for example, one or more actuators (e.g., one or more motors), low-level software, and/or a simulator. As will be described later, a processor (e.g., a processor 1120 of FIG. 11) of the electronic device may independently transition the state of the electronic device several times with respect to one goal determined using the goal determining model 230, using the controller 250.

In this disclosure, a step length may include a plurality of time steps. The time step may be a unit time length. The electronic device 200 may call, operate, and/or implement any one or any combination of any two or more of the aforementioned models for each time step.

The electronic device 200 may transmit the skill vector determined using the skill determining model 220 to the goal determining model 230. The electronic device 200 may maintain the skill determined using the skill determining model 220 for a predetermined first number of times. For example, the electronic device 200 may transmit the skill vector determined using the skill determining model 220 to the goal determining model 230 as described above for the predetermined first number of times. The predetermined first number of times may be expressed as a skill maintenance length lₘ. For example, the electronic device 200 may call the goal determining model 230 by the number of calls corresponding to the first predetermined number. The skill maintenance length lₘ be set to a fixed value. When the skill determination using the skill determining model 220 is performed, the electronic device 200 may perform goal determination using the goal determining model 230 during the skill maintenance length lₘ and call the skill determining model 220 again.

In addition, the electronic device 200 may transmit the goal vector determined using the goal determining model 230 to the action determining model 240. The electronic device 200 may maintain the goal determined using the goal determining model 230 for a predetermined second number of times. For example, the electronic device 200 may transmit the goal vector determined using the goal determining model 230 to the action determining model 240 for the predetermined second number of times. The predetermined second number of times may also be expressed as a goal maintenance length l. The goal maintenance length l may include, for example, l unit type steps. The goal maintenance l length may be determined according to the number of actions required (or determined to be required) to achieve the goal g given from the current state sₜ. For example, the electronic device 200 may call the action determining model 240 by the number of calls corresponding to the predetermined second number. The electronic device 200 may determine the action from the observed state for the goal maintained during the goal maintenance length l. The electronic device 200 may sequentially repeat an action determination using the action determining model 240 and a control of the controller 250 through the determined action for each goal g based on the goal maintenance length l. The state transition may occur l times under the control of the controller 250. Therefore, the electronic device 200 may acquire a state trajectory (s₀, a₀, . . . , sₗ₋₁, aₗ₋₁, sₗ) according to the state transition occurring l times. In this disclosure, the state trajectory may be a sequential combination of states and actions for each time step, and/or may also be referred to as an action trajectory. When l state transitions for one goal are completed, the electronic device 200 may calculate (e.g., determine) a new goal by using the goal determining model 230. At this time, the electronic device 200 may calculate a new skill by using the skill determining model 220 each time that the number of calls of the goal determining model 230 exceeds lₘ. The electronic device 200 may provide the same skill (e.g., the same skill as a previous time step) to the goal determining model 230 until the number of calls of the goal determining model 230 exceeds lₘ. For example, the electronic device 200 may skip calculating a new skill until the skill maintenance length lₘ elapses. As a result, the electronic device 200 may acquire a state trajectory of a length lₘ_{_{×}}l.

The electronic device 200 may control an abstracted environment through the action determining model 240 by setting a goal using the goal determining model 230. Accordingly, even when an environment is relatively complex, the electronic device 200 of one or more embodiments may exhibit better performance compared to a typical electronic device that determines an action using a goal calculated from the state.

For reference, the electronic device 200 may further include a goal sampling model and a trajectory encoder for information bottleneck-based skill discovery. A non-limiting example description of such will be made with reference to FIG. 7.

FIG. 3 illustrates an example of a linearized state transition according to an action determined by an action determining model.

An electronic device may determine, based on a state and a determined goal, an action that causes or results in a linear state transition of the electronic device in a direction toward the determined goal in a state space 320. For example, the electronic device may determine an action vector representing an action from a skill vector representing an observed state and a goal skill vector representing a determined goal, using an action determining model based on machine learning. The electronic device may output data indicating an action determined using the action determining model based on a state and a goal. For convenience of description, FIG. 3 illustrates a goal latent space 310 and the state space 320 in two dimensions, but it is merely an example.

The action determining model may also be expressed as, or include, a linearization policy π^{lin}(aₜ|sₜ, gₜ)). Here, aₜ denotes an action of a t-th time step, sₜ denotes a state of the t-th time step, and gₜ denotes a goal given at the t-th time step. The linearization policy π^{lin}(aₜ|sₜ, gₜ)) may be designed or configured to maximize the state transition from the current state sₜ to the goal g in the state space 320. An output of the linearization policy π^{lin}(aₜ|sₜ, gₜ)) may include, for example, an average point and variance for each dimension of a multidimensional action latent space. The electronic device may determine an action vector determined through a probability trial using a probability distribution output from π^{lin}(aₜ|sₜ, gₜ)) or the action vector (e.g., action vector representing a point indicated by the mean in the output of the action determining model) that maximizes a value of π^{lin}(aₜ|sₜ, gₜ)). The linearization policy π^{lin}(aₜ|sₜ, gₜ)) is a conditional policy, and each variable may be defined by a skill vector sₜ∈R^{d} and a goal skill vector gₜ∈[−1,1]^{d}. For example, each dimension of the goal skill vector in the goal latent space 310, which is determined using the goal determining model, may have a value between −1 and 1, inclusive. However, a range of the value of the goal skill vector is not limited thereto.

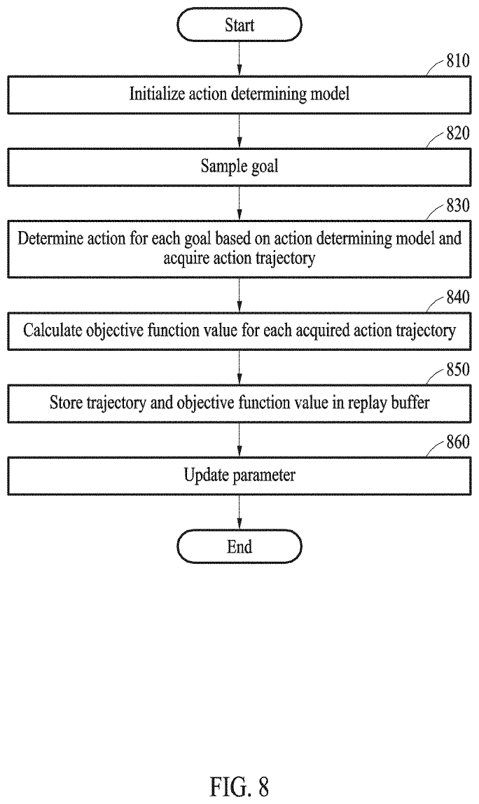

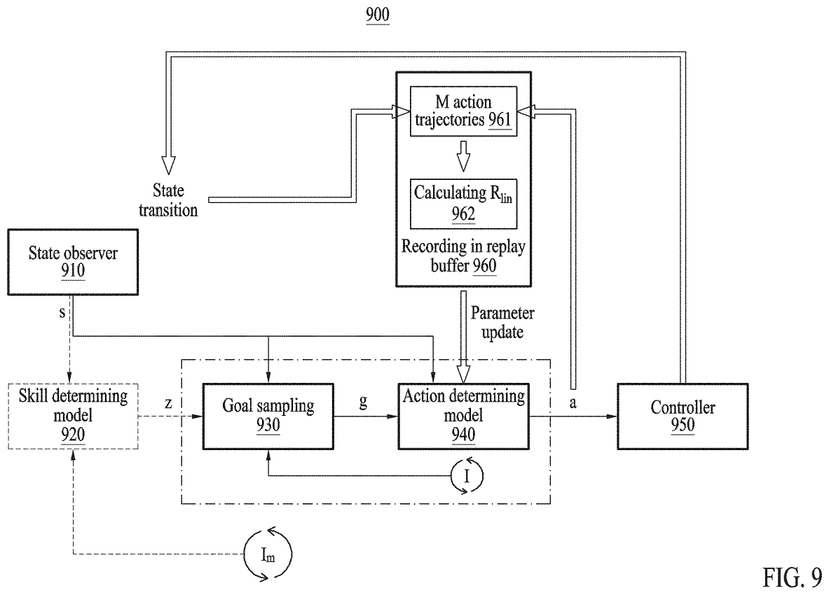

For reference, the action determining model may be trained independently of other models. For example, the action determining model may be trained before the goal determining model, the goal sampling model, and the trajectory encoder are trained. For a goal skill vector gₜ newly given every I step, the linearization policy may acquire a reward described with reference to FIGS. 8 and 9, as a non-limiting example. The electronic device may train the action determining model in which the linearization policy π^{lin}(aₜ|sₜ, gₜ)) is implemented using the objective function described in FIGS. 8 and 9 below. Through this, the electronic device may increase (e.g., maximize) a state transition of a reinforcement learning agent from the state sₜ toward the goal gₜ in the state space 320.

The linearization policy implemented by the action determining model may be interpreted as being responsible for, or resulting in, the movement of the agent in the state space 320. Instead of transmitting the state and/or skill directly to the action determining model, the electronic device of one or more embodiments may transmit a goal determined using the goal determining model to the action determining model, thereby controlling the reinforcement learning agent at an abstract level rather than a low level. Accordingly, the electronic device of one or more embodiments may escape from low-level direct interaction with a complex environment and use more efficiently learned skills.

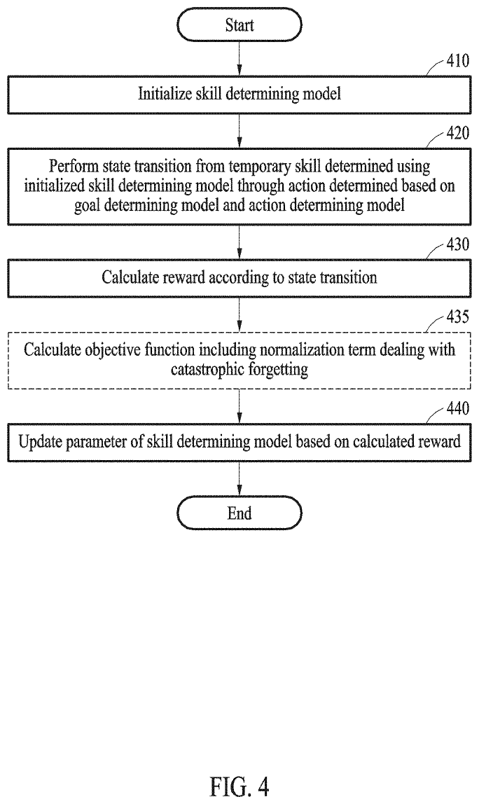

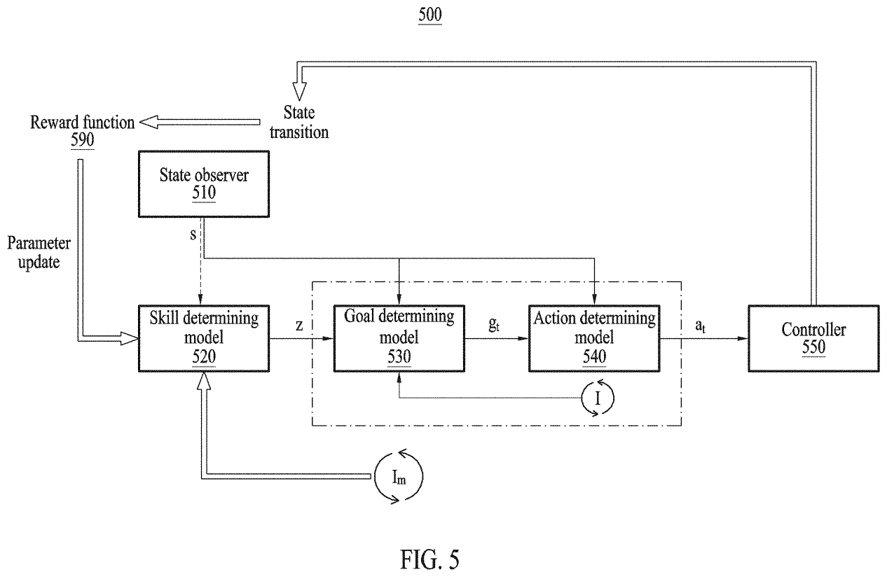

FIGS. 4 and 5 illustrate examples of training a skill determining model.

An electronic device 500 may train a skill determining model 520 offline.

In operation 410, the electronic device 500 may initialize the skill determining model 520. For example, the electronic device 500 may initialize a parameter of the skill determining model 520 to a random value. The electronic device 500 may load a goal determining model 530 and an action determining model 540 trained in advance.

In operation 420, the electronic device 500 may perform a state transition from a temporary skill determined using the initialized skill determining model 520 through an action determined using the goal determining model 530 and the action determining model 540. The temporary skill may represent the skill vector determined based on data output from the temporary skill determining model 520. The temporary skill determining model 520 may be the skill determining model 520 of which training has not been completed. The electronic device 500 may determine a temporary skill using the skill determining model 520 with respect to a state observed by a state observer 510. The electronic device 500 may determine a goal using the goal determining model 530 based on the temporary skill and the observed state. The electronic device 500 may determine an action using the action determining model 540 based on the goal and the observed state. The electronic device 500 may cause an occurrence of a state transition of the electronic device 500 by controlling a controller 550 with the determined action. In the above-described example, when a skill maintenance length is lₘ and a goal maintenance length is l, the state transition may occur lₘ_{_{×}}l times.

In operation 430, the electronic device 500 may calculate a reward according to a state transition by an action performed by the controller 550. For example, when the reward is obtained from the environment and when the reward is infrequent, the electronic device 500 may calculate a value of an internal reward function 590 using known exploration methods (e.g., Episodic Curiosity (Savinov et al., 2018) and Curiosity Bottleneck (Kim et al., 2019)).

In operation 440, the electronic device 500 may update a parameter of the skill determining model 520 based on the calculated reward. For example, the electronic device 500) may update a parameter of the skill determining model 520 in which a policy function is π_{ξ}(z|s) implemented, using a policy gradient descending method (e.g., REINFORCE, PPO (Schulman et al., 2017) and Soft Actor-Critic (Haarnoja et al., 2018)).

The electronic device 500 may repeat the above-described operations 420 through 440 until the parameter of the skill determining model 520 converges.

In addition, the electronic device 500 may calculate an objective function including a normalization term dealing with catastrophic forgetting in operation 435. In neural network-based online learning, catastrophic forgetting may occur. Apart from the objective function and/or reward based on the aforementioned reward, the electronic device 500 may additionally calculate a normalization term to prevent catastrophic forgetting of the parameter. The normalization term is a term indicating a distance from an existing parameter, and may be calculated using a method such as elastic weight consolidation (EWC, Kirkpatrick et. al., 2017), variational continual learning (VCL, Nguyen et. al., 2018), meta-learning for online learning (MOLe, Nagabandi et. al., 2019), and the like. The electronic device 500 may update the parameter of the skill determining model 520 through a gradient descending method to minimize a value of the normalization term. In online learning, the electronic device 500 may repeat the above-described operations 420, 430, 435, and 440 until no additional data input is made.

The electronic device 500 may exhibit high performance in AntGoal, AntMultiGoals, CheetahGoal, and Cheetah Imitation environments in which Ant and HalfCheetah environments are modified.

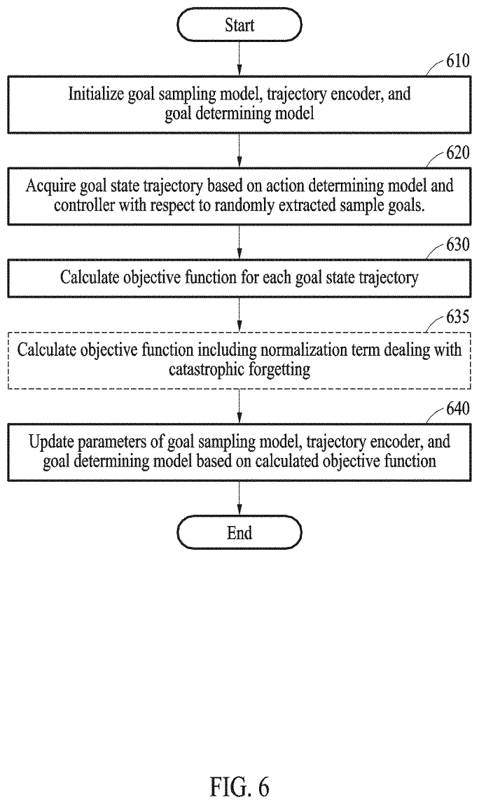

FIGS. 6 and 7 illustrate examples of training a goal determining model.

An electronic device 700 may train a goal determining model 730 based on a skill discovery with information bottleneck. For example, the electronic device 700 may further include a goal sampling model 732 and a trajectory encoder 760 to train the goal determining model 730. The electronic device 700 may train a skill determining model 720 jointly with the goal sampling model 732 and the trajectory encoder 760 based on Equation 1 described later, for example.

As described above, the goal sampling model 732 may be modeled with π_{θ}_{ₛ}(gₜ|sₜ, u). For example, the goal sampling model 732 may exhibit similar expressive power to the goal determining model 730 modeled with π_{θ}_{ₛ}(gₜ|sₜ, u). For the aforementioned goal sampling, u may be introduced as a context variable. The context variable u may be a skill vector (e.g., sample skill vector) indicating a sample skill extracted from a skill latent space.

In operation 610, the electronic device 700 may initialize the goal sampling model 732, the trajectory encoder 760, and the goal determining model 730. For example, the electronic device 700 may initialize a parameter θₛ of the goal sampling model 732, a parameter ϕ of the trajectory encoder 760, and a parameter θ_{z} of the goal determining model 730 as random values. The electronic device 700 may load an action determining model 740 trained in advance.

In operation 620, the electronic device 700 may acquire a goal state trajectory 751 using the action determining model 740 and a controller 750 with respect to randomly extracted sample goals. The electronic device 700 may extract sample goals of the goal sampling model 732 from randomly extracted sample skills 731. The electronic device 700 may acquire the goal state trajectory 751 using the action determining model 740 and the controller 750 with respect to the extracted sample goals. For example, the electronic device 700 may sample a sample skill u from a normal distribution r(z)=N(0, I) having the same mean and variance as a skill latent variable z. For example, the electronic device 700 may extract a sample goal gₜ for the random sample skill u for each state observed by a state observer 710. The electronic device 700 may acquire the goal state trajectory 751, τ=(sₜ, gₜ, . . . g_{t+T-1}, s_{t+T}) of a length T using the goal sampling model 732 and the action determining model 740. The goal state trajectory 751 may be a trajectory indicating a sequential combination of actions and states for each time step. For reference, a state transition by an action determined using the action determining model 740 may occur a total of T·l times but may be recorded only in T time steps in the above-described goal state trajectory 751.

The electronic device 700 may acquire a total of n goal state trajectories 752 by repeating operation 620 n times. The length of each of the goal state trajectory 751 may be T, and each trajectory may be expressed as τ⁽¹⁾, . . . , τ⁽ⁿ⁾, for example. The electronic device 700 may sample n random sample skills u, and may acquire the goal state trajectory 751 for each of the sample skills u sampled.

In operation 630, the electronic device 700 may calculate an objective function for each goal state trajectory 751. For example, the electronic device 700 may calculate the above-described information bottleneck term (e.g., Equation 2 below) for the sample goal gₜ extracted for each randomly sampled skill u as the objective function. For example, an information bottleneck value according to the following Equation 1 with a hyperparameter β may be considered.

[symbol]

ₜ[I(Z;Gₜ|Sₜ)−β·I(Z;S_{0:T})] Equation 1:

In Equation 1, I( ) may be a function representing mutual information (MI) between two random variables. The mutual information may represent a measure of the mutual dependence between two random variables in probability theory and information theory. Eₜ[ ] may be a function representing an expected value for a time step t in an episode. Z denotes a random variable representing a skill, Gₜ denotes a probability variable representing a goal, and Sₜ denotes a random variable representing a state. S_{0:T} denotes the state trajectory 751 and may include states only. In Equation 1, a first term is a term for preserving an amount of information related to the goal, and a second term is a term for preserving an amount of information related to the trajectory. The two terms may be in a trade-off relationship with each other, and the trade-off may be controlled by the aforementioned β.

However, since it is impossible to accurately calculate an information bottleneck value according to Equation 1, a lower bound of the information bottleneck according to Equation 2 may be calculated as an information bottleneck reward 770. This is because, when the lower bound of the information bottleneck is maximized, the information bottleneck value according to Equation 1 is maximized.

$${𝔼}_{{u \sim p ( u ) ,}_{τ \sim {p}_{{θ}_{s}} ( τ \vert )}} [ {𝔼}_{{{z \sim {p}_{ϕ} ( z \vert {s}_{0 : T} ) , t}_{i . i . d .}}_{{u}_{i} \sim p ( u )}} [ {J}^{P} ] - β \cdot {J}^{C} + λ \cdot {p}_{ϕ} ( u \vert {s}_{0 : T} ) ] \qquad Equation 2$$

$$where {J}^{P} = log {π}_{{θ}_{z}} ( {g}_{t} \vert {s}_{t} , z ) - log ( \frac{1}{L} {\sum }_{i = 1}^{L} {π}_{{θ}_{s}} ( {g}_{t} \vert {s}_{t} , {u}_{i} ) )$$

$${J}^{C} = {D}_{KL} ( {p}_{ϕ} ( Z \vert {s}_{0 : T} ) ‖ r ( Z ) ) .$$

In Equation 2, J^{P} denotes a prediction term of an information bottleneck corresponding to the first term of Equation 1. J^{C} denotes a compression term of an information bottleneck corresponding to the second term of Equation 1. D_{KA} denotes Kullback-Leibler divergence (KLD). p_{θ}_{ₛ}(τ∥u) denotes a distribution

$$p ( {s}_{0} ) {\prod }_{t = 0}^{T - 1} {π}_{{θ}_{s}} ( {g}_{t} \vert {s}_{t} , u ) \cdot p ( {s}_{t} , {g}_{t} )$$

of a trajectory τ=(s₀, g₀, . . . , g_{T-1}, s_{T}). is a constant representing a number of samples uᵢ sampled from a prior distribution p(u) of u for use in approximation, and may be specified by a person. For example, L=100. r(Z) may be a distribution approximating an unconditional distribution p_{φ(Z)} (for example, not a conditional distribution) of z provided by the trajectory encoder as an output.

Through a parameter update based on the prediction term J^{P}, the goal determining model 730 may be trained to output various goals for each skill latent variable. Through a parameter update based on the compression term J^{C}, the trajectory encoder 760 may be trained to extract a skill latent variable including useful information for inferring goals from the trajectories.

The electronic device 700 may calculate the information bottleneck reward 770 according to Equation 2 for each goal state trajectory 751 and may calculate a statistical value (e.g., mean) of the information bottleneck reward 770 calculated for all trajectories as an objective function value.

In operation 640, the electronic device 700 may update parameters of the goal sampling model 732, the trajectory encoder 760, and the goal determining model 730 based on the calculated objective function. For example, the electronic device 700 may update any one or any combination of any two or more of the parameters of the goal determining model 730, the goal sampling model 732, and the trajectory encoder 760 such that the value of the information bottleneck term is maximized. As described above, the goal determining model 730 may be trained to improve correspondence between trajectories and variables in a space of the trajectories, for example, to increase the amount of mutual information. The electronic device 700 may calculate a gradient with respect to the parameter θ_{z} of the goal determining model 730 and the parameter ϕ of the trajectory encoder 760 from the objective function calculated in operation 630. The electronic device 700 may also calculate the policy gradient for the goal sampling model 732. The electronic device 700 may update the parameter θₛ of the goal sampling model 732, the parameter θ_{z} of the goal determining model 730, and the parameter ϕ of the trajectory encoder 760 using the gradient ascending method. The electronic device 700 may repeat operations 620 through 640 until the parameters θₛ, θ_{z}, and ϕ of the models converge.

When the training is completed, the trajectory encoder 760 and the goal sampling model 732 may be removed because they are unnecessary for task inference. However, it is merely an example, and the trajectory encoder 760 and the goal sampling model 732 may be maintained for additional training (e.g., adaptive training) based on online learning of the goal determining model 730.

In addition, the electronic device 700 may calculate an objective function including a normalization term dealing with catastrophic forgetting in operation 635. Since the normalization term has been described above, a detailed description thereof will be omitted. In this case, in operation 640, the electronic device 700 may linearly combine the objective function according to operation 630 and the normalization term according to operation 635, thereby calculating the parameter θ_{z} of the goal determining model 730, a gradient with respect to the parameter ϕ of the trajectory encoder 760, and the policy gradient with respect to the goal sampling model 732. The electronic device 700 may repetitively update the parameters θₛ, θ_{z}, and ϕ of the models by repeating operations 620 through 640 until no additional data input is made in online learning.

As described above, the electronic device 700 may learn various skills that are distinguished from each other in an unsupervised manner. The electronic device 700 may have skills that are diverse and different in various environments and learned to explore the entire space. The electronic device 700 may exhibit high average performance in all environments and evaluation indicators.

FIGS. 8 and 9 illustrate examples of training an action determining model.

In operation 810, an electronic device 900 may initialize an action determining model 940. For example, the electronic device 900 may initialize a parameter of the action determining model 940 to a random value. In addition, the electronic device 900 may initialize a trajectory replay buffer 960.

In operation 820, the electronic device 900 may sample a goal. For example, the electronic device 900 may sample m goal states 930 from a uniform distribution having a range of [−1,1], m being an integer of 1 or more.

In operation 830, the electronic device 900 may determine an action for each goal using the action determining model 940 and acquire an action trajectory. For reference, a state to be used in the action determining model 940 may be observed by a state observer 910 and may be transitioned by a controller 950. For example, the electronic device 900 may acquire the action trajectory by determining an action using the action determining model 940 for each sampled goal. A length of an action trajectory for one goal may be l. Since the m goal states 930 are sampled in operation 820, the electronic device 900 may acquire an action trajectory (s₀, a₁, . . . , a_{l·m-1}, s_{l·m}) of a length l×m. This is because the trajectory of the length l is sampled m times.

In operation 840, the electronic device 900 may calculate an objective function value for each acquired action trajectory. For example, the electronic device 900 may calculate an objective function value 962 according to Equation 3.

$${R}^{lin} ( {s}_{t} , {g}_{t} , {a}_{t} , {s}_{t + 1} ) = \frac{1}{l} {( {s}_{( c + 1 ) \cdot l} - {s}_{c \cdot l} )}^{T} {g}_{t} \qquad Equation 3$$

In Equation 3,

$$c = floor {( \frac{t}{l} )}_{.} {g}_{t} = {g}_{t - 1} , ∀ t \neq 0 ( mod l ) ,$$

which may indicate that a new goal is extracted every l steps. According to the linearization policy, a greater reward may be obtained as farther extension is made in a direction to gₜ through a movement s_{(c+1)·l}−s_{c·l} of every l steps. In a comparative example, when the action is randomly determined, the agent may remain in place without showing any significant movement. In contrast, the electronic device 900 may present a correct learning goal to a machine learning model by encouraging the agent to reach far using Equation 3.

In operation 850, the electronic device 900 may store the trajectory and the objective function value 962 in the replay buffer 960. The electronic device 900 may store M action trajectories 961 by repeating operations 820 through 840 M times, M being an integer of 1 or more.

In operation 860, the electronic device 900 may update a parameter of the action determining model 940. The electronic device 900 may update the parameter of the action determining model 940 based on the stored action trajectory and the objective function value 962. For example, the electronic device 900 may update the parameter of the action determining model 940 using a soft actor-critic (SAC) method (e.g., Haarnoja et al., 2018).

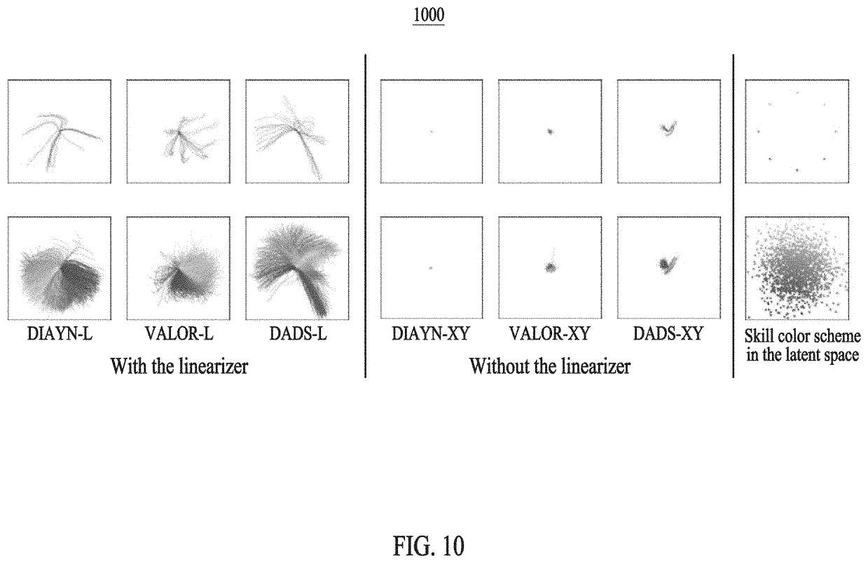

FIG. 10 illustrates a state space discovery ability by an action determining model.

FIG. 10 illustrates a state space discovery ability 1000 of an electronic device using an action determining model in which a linearizer policy is implemented. In FIG. 10, “−L” indicates a trajectory in a state space by an agent according to an example in which the action determining model is used. In addition, “−XY” indicates a trajectory in a state space by an agent according to a comparative example for directly determining an action from a goal without using the action determining model. It is shown that an explorable range of the action trajectory is explicitly distinguished by skill latent variables distinguished from each other in the electronic device using the action determining model.

FIG. 11 is a block diagram illustrating an example of an electronic device.

An electronic device 1100 may perform a goal task using a skill determining model, a goal determining model, an action determining model, and a controller 1140 as described above, or may perform training based on reinforcement learning of the aforementioned models. The goal task may include a control and an operation of a device responding to a change in a given environment (e.g., a physical environment around the device or a virtual environment accessible by the device). The electronic device 1100 may train each model online and/or offline according to the methods described with reference to FIGS. 1 through 10.

The electronic device 1100 is, for example, any one or any combination of any two or more of a storage management device, an image processing device, a mobile terminal, a smartphone, a foldable smartphone, a smart watch, a wearable device, a tablet computer, a netbook, a laptop, a desktop, a personal digital assistant (PDA), a set-top box, a home appliance, a biometric door lock, a security device, a financial transaction device, a vehicle starting device, an autonomous vehicle, a robot cleaner, a drone, and the like. However, an implementation of the electronic device 1100 is not limited to the example.

The electronic device 1100 includes a state observer 1110, a processor 1120 (e.g., one or more processors), a memory 1130 (e.g., one or more memories), and the controller 1140.

The state observer 1110 may observe a state of the electronic device 1100 according to an environment interactable with the electronic device 1100. For example, the state observer 1110 may perform either one or both of sensing a change in the physical environment for the electronic device 1100 and collecting data change related to the virtual environment. The state observer 1110 may include a network interface and various sensors. The network interface may communicate with an external device through a wired or wireless network, and may receive a data stream. The network interface may receive data that is changed in relation to the virtual environment. The sensors may include a camera sensor, an infrared sensor, a lidar sensor, and a vision sensor. However, it is merely an example, and the sensors may include a variety of modules capable of sensing different types of information, including ultrasonic sensors, current sensors, voltage sensors, power sensors, thermal sensors, position sensors (such as global navigation satellite system (GNSS) modules), and electromagnetic wave sensors.

The processor 1120 may determine a skill based on the observed state. The processor 1120 may determine a goal based on the determined skill and the observed state. The processor 1120 may determine an action causing a linear state transition of the electronic device 1100 in a direction toward the determined goal in a state space based on the state and the determined goal. However, the operation of the processor 1120 is not limited thereto, and any one or any combination of any two or more of the operations described above with reference to FIGS. 1 through 10 may be performed simultaneously or in parallel. The processors 1120 may perform any one, any combination of, or all operations and methods described herein with respect to FIGS. 1-11.

The controller 1140 may control an operation of the electronic device 1100 based on the determined action. The controller 1140 may include an actuator (e.g., a motor) that performs physical deformation and movement of the electronic device 1100. However, it is merely an example, and the controller 1140 may include an element for controlling an electrical signal (e.g., current and voltage) inside the device. In the electronic device 1100 for the virtual environment, the controller 1140 may include a network interface for requesting data change to a server in the virtual environment. However, it is merely an example, and the controller 1140 may include a module capable of performing an operation and/or function for causing a state transition in the state space of the electronic device 1100.

In an example, the electronic device 1100 may be implemented as a robot cleaner. The state observer 1110 of the electronic device 1100 implemented as the robot cleaner may include a sensor that senses information for localization of the electronic device 1100 in a designated physical space (e.g., indoor). For example, the state observer 1110 may include any one or any combination of any two or more of a camera sensor, a radar sensor, an ultrasonic sensor, a distance sensor, and an infrared sensor. The electronic device 1100 may determine a state of the electronic device 1100 (e.g., a location of the electronic device 1100 in a designated physical space and a clean state for each point in the space) based on the above-described sensor. The electronic device 1100 may determine a skill based on a state, determine a goal (e.g., a spot to be cleaned) from the determined skill and the goal, and perform an action (e.g., driving a motor for movement in a corresponding direction) to achieve the determined goal.

In an example, the electronic device 1100 may be implemented as a voice assistant. In the electronic device 1100 implemented as the voice assistant, a state space may include a function and/or a region (e.g., a region of the memory 1130 and a screen region) accessible by the voice assistant. The state observer 1110 may include a sound sensor. The electronic device 1100 may determine a state of the electronic device 1100 (e.g., a state in which an order to find a restaurant is received) using information (e.g., speech command““find restauran”” received from user) collected based on the above-described sensor. The electronic device 1100 may determine a skill based on a state, determine a goal (e.g., a direction to face a state in which information about nearby restaurants is displayed on the screen) from the determined skill and the state, and perform an action to achieve the determined goal (e.g., measuring a geographic location of the electronic device 1100, collecting information about nearby restaurants through communication, and outputting the collected information on the screen).

However, an application of the electronic device 1100 is not limited to the foregoing examples. In an example, the electronic device 1100 may be used to provide a dynamic recommendation in a space (e.g., physical space and virtual space) where an arbitrary action and/or event occurs. For example, the electronic device 1100 may be implemented as a smartphone or a virtual reality device, and may be used for learning and controlling a non-playable character (NPC) in a game. In a case of a movement problem in the game, a space of a virtual environment in the game is a state space, and in a case of an action problem, a state space mixed with actions allowed for the NPC may be used. Also, in an example, the electronic device 1100 may be installed in a robot arm used in a process so as to be used for learning and a control thereof. As such, reinforcement learning may be used for an automated control process and thus, used in situations where automatic control needs to be performed in a complex environment.

§ The electronic devices, state observers, controllers, trajectory encoders, replay buffers, processors, memories, electronic device 200, state observer 210, controller 250, electronic device 500, state observer 510, controller 550, electronic device 700, controller 750, trajectory encoder 760, electronic device 900, state observer 910, controller 950, replay buffer 960, electronic device 1100, state observer 1110, processor 1120, memory 1130, controller 1140, and other apparatuses, units, modules, devices, and components described herein with respect to FIGS. 1-11 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular t“rm “proce”sor””or “comp”ter” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-11 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, bD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

What is claimed is:

1. An electronic device, comprising:
a state observer configured to observe a state of the electronic device according to an environment interactable with the electronic device;
one or more processors configured to:
determine a skill based on the observed state;
determine a goal based on the determined skill and the observed state; and
determine, based on the state and the determined goal, an action causing a linear state transition of the electronic device in a direction toward the determined goal in a state space; and
a controller configured to control an operation of the electronic device based on the determined action.

2. The electronic device of claim 1, wherein, for the observing, the state observer is configured to perform either one or both of sensing a change in a physical environment for the electronic device and collection of a data change related to a virtual environment.

3. The electronic device of claim 1, wherein, for the determining of the skill, the one or more processors are configured to determine a skill vector representing the skill to be applied to the observed state, based on a state vector representing the observed state, using a skill determining model based on machine learning.

4. The electronic device of claim 3, wherein the one or more processors are configured to:
control the controller with an action determined using an action determining model and a goal determining model based on a temporary skill determined using a skill determining model for an observed state;
determine a reward according to a state transition by the action performed by the controller; and
update a parameter of the skill determining model based on the determined reward.

5. The electronic device of claim 1, wherein, for the determining of the goal, the one or more processors are configured to determine a goal state vector representing the goal, based on a state vector representing the observed state and a skill vector representing the determined skill, using a goal determining model based on machine learning.

6. The electronic device of claim 5, wherein the one or more processors are configured to:
determine a goal state trajectory using the controller and an action determining model for sample goals extracted from randomly extracted sample skills using a goal sampling model;
determine a value of an objective function for each goal state trajectory; and
update a parameter of the goal determining model based on the determined objective function.

7. The electronic device of claim 1, wherein, for the determining of the action based on the state and the determined goal, the one or more processors are configured to determine an action vector representing the action, based on a state vector representing the observed state and a goal state vector representing the determined goal, using an action determining model based on machine learning.

8. The electronic device of claim 7, wherein the one or more processors are configured to:
determine an action trajectory by determining an action using the action determining model for each sampled goal;
determine an objective function value for each determined action trajectory;
store the action trajectory and the objective function value in a replay buffer; and
update a parameter of the action determining model based on the stored action trajectory and the objective function value.

9. The electronic device of claim 1, wherein, for the determining of the goal, the one or more processors are configured to determine the goal based on the determined skill and the observed state while maintaining the determined skill for a predetermined number of times using a skill determining model.

10. The electronic device of claim 1, wherein the one or more processors are configured to determine the action based on the determined goal and the observed state while maintaining the determined goal for a predetermined number of times using a goal determining model.

11. A processor-implemented method, the method comprising:
observing a state of the electronic device according to an environment interactable with the electronic device;
determining a skill based on the observed state;
determining a goal based on the determined skill and the observed state;
determining an action causing a linear state transition of the electronic device in a direction toward the determined goal in a state space based on the state and the determined goal; and
controlling an operation of the electronic device based on the determined action.

12. The method of claim 11, wherein the observing comprises performing either one or both of sensing a change in a physical environment for the electronic device and collection of a data change related to a virtual environment.

13. The method of claim 11, wherein the determining of the skill comprises determining a skill vector representing the skill to be applied to the observed state, based on a state vector representing the observed state, using a skill determining model based on machine learning.

14. The method of claim 13, further comprising:
controlling a controller with an action determined using an action determining model and a goal determining model based on a temporary skill determined using a skill determining model for an observed state;
determining a reward according to a state transition by the action performed by the controller; and
updating a parameter of the skill determining model based on the determined reward.

15. The method of claim 11, wherein the determining of the goal comprises determining a goal state vector representing the goal, based on a state vector representing the observed state and a skill vector representing the determined skill, using a goal determining model based on machine learning.

16. The method of claim 15, further comprising:
determining a goal state trajectory using a controller and an action determining model for sample goals extracted from randomly extracted sample skills using a goal sampling model;
determining a value of an objective function for each goal state trajectory; and
updating a parameter of the goal determining model based on the determined objective function.

17. The method of claim 11, wherein the determining of the action based on the state and the determined goal comprises:
determining an action vector representing the action, based on a state vector representing the observed state and a goal state vector representing the determined goal, using an action determining model based on machine learning.

18. The method of claim 17, comprising:
determining an action trajectory by determining an action using the action determining model for each sampled goal;
determining an objective function value for each determined action trajectory;
storing the action trajectory and the objective function value in a replay buffer; and
updating a parameter of the action determining model based on the stored action trajectory and the objective function value.

19. The method of claim 11, wherein the determining of the goal comprises determining the goal based on the determined skill and the observed state while maintaining the determined skill for a predetermined number of times using a skill determining model.

20. A non-transitory computer-readable storage medium storing instructions that, when executed by one or more processors, configure the one or more processors to perform the method of claim 11.

21. A processor-implemented method, the method comprising:
one or more processors configured to:
determine, using a skill determining model, a skill based on a state of the electronic device observed according to an environment interactable with the electronic device;
determine, using goal determining model, a goal based on the determined skill and the observed state;
determine, using an action determining model, an action causing a state transition of the electronic device based on the state and the determined goal; and
update, based on the determined action, a parameter of any one or any combination of any two or more of the skill determining model, the goal determining model, and the action determining model.

22. The electronic device of claim 21, further comprising:
a state observer configured to observe the state of the electronic device; and
a controller configured to control an operation of the electronic device based on the determined action.

23. The electronic device of claim 22, wherein
for the observing of the state, the state observer comprises one or more sensors configured to sense the state of the electronic device, and
for the controlling of the operation, the controller comprises one or more actuators configured to control a movement of the electronic device.
